(19) United States
(12) Patent Application Publication
(10) Pub. No.: US 2007/0110950 A1
(43) Pub. Date: May 17, 2007

(54) One piece floor mat for use as vehicle floor mat, doormat and sports mat

(75) Inventor: Ming-Shun Yang, Taipei (TW)

Correspondence Address: TROXELL LAW OFFICE PLLC, SUITE 1404, 5205 LEESBURG PIKE, FALLS CHURCH, VA, 22041, US

(73) Assignee: Formosa Saint Jose Corp.

(21) Appl. No.: 11/271,896

(22) Filed: Nov. 14, 2005

(51) Int. Cl. B32B 33/00; B32B 3/02

(52) U.S. Cl. 428/95; 428/96

(57) ABSTRACT

A one piece floor mat for use as a vehicle floor mat, doormat and sports mat comprises a mat body of three-layer materials, including an upper layer, a middle layer and a lower layer. The three layers are laminated to bond together without the application of any additional solvent glue or adhesive. The middle layer is a relatively thick layer of a cross-link polythene foam material or an EVA foam material, upon which a layer of durable weave cloth, non-woven fabric, fluffy rug, textile rug, anti-slip thermoplastic rubber (TPR) or thermoplastic elastomer (TPE); whereas the lower layer is a layer of anti-slip thermoplastic rubber (TPR). The three-layer mat is heated to soften and put into a mold to press and form an upstanding rim at the contour, or relief grooves and protrusions as desired on the mat surface.

### BACKGROUND OF THE INVENTION

(a) Field of the Invention

The present invention relates to a floor mat, which has a bottom that is anti-slip and gas permeable. The integral mat can be served as vehicle floor mat, luggage pallet mat, or a flat doormat, yoga mat for sports purposes, or the like.

(b) Description of the Prior Art

Conventional mats are disposed on the ground for serving as foot mats or for scrubbing the dirt off the shoe soles, such that the dirt carried by the shoes would leave on the foot mats without being brought indoor, thereby keeping the house in a clean condition. Besides, when one walks out of wet bathroom, he/she can step on the mat to have the water absorbed, so as to avoid the danger of slip. And, when the mat is applied onto a vehicle floor, when the driver or passengers enter into the vehicle, the dirt carried by their shoes will fall on the mat, so as to keep the vehicle a clean environment.

The mat can be made of various materials depending on the specific need in usage. Taking an indoor mat for example, it is generally made of single material such as fabric or rug for absorbing water only. As for anti-slip purposes, an anti-slip structure need be provided under the fabric/rug of the mat.

Accordingly, there is a need to have the mat structure made as anti-slip, easily produced, economic in manufacture cost and durable, i.e. excellent in quality and reasonable in price.

### SUMMARY OF THE INVENTION

The primary object of the invention is to provide a one piece floor mat for use as vehicle floor mat, doormat and sports mat, which can allow the mat bottom efficiently anti-slip and water-proof such that the water accumulated on or absorbed to the mat surface will not permeable to the mat bottom.

Another object of the invention is to provide a one piece floor mat for use as vehicle floor mat, doormat and sports mat, which is composed of three layers of materials which are bonded to one another without the application of any solvent glue or adhesive. As the three layers are laminated firmly without the risk of remaining any harmful solvent to the user, it is in an excellent environmental sense.

To obtain the above objects, the invention comprises a mat body of three-layer materials, including an upper layer, a middle layer and a lower layer. The three layers are laminated to bond together without the application of any additional solvent glue or adhesive. The middle layer is a relatively thick layer of a cross-link polythene foam material or an ethylene-vinyl acetate (EVA) foam material, upon which a layer of durable weave cloth, non-woven fabric, fluffy rug, textile rug, anti-slip thermoplastic rubber (TPR) or thermoplastic elastomer (TPE); whereas the lower layer is a layer of anti-slip thermoplastic rubber (TPR). The composite three-layer mat body is cut into appropriate sizes and contours, heated in an oven to soften, and then put into a mold to press and form a basin with an upstanding rim for serving as a vehicle floor mat or a luggage pallet mat. Alternatively, the mat can be heated to soften, and then put into a mold to press and form relief grooves and protrusions as desired on the mat surface, to enhance the friction factor between the mat surface and the contact object, thus increasing the anti-slip function.

To completely appreciate these and other objects of the present invention as well as the invention itself, all of which will become apparent to those skilled in the art, the following detailed description of the invention and the claims should be read in conjunction with the accompanying drawings.

### BRIEF DESCRIPTION OF THE DRAWINGS

FIG. 1 is an exploded view of the present invention.

FIG. 2 is a perspective view of an embodiment of the invention.

FIG. 3 is a cut-away view of the invention.

FIG. 4 shows application of the invention as a doormat.

FIG. 5 shows application of the invention as a yoga mat.

### DETAILED DESCRIPTION OF THE PREFERRED EMBODIMENTS

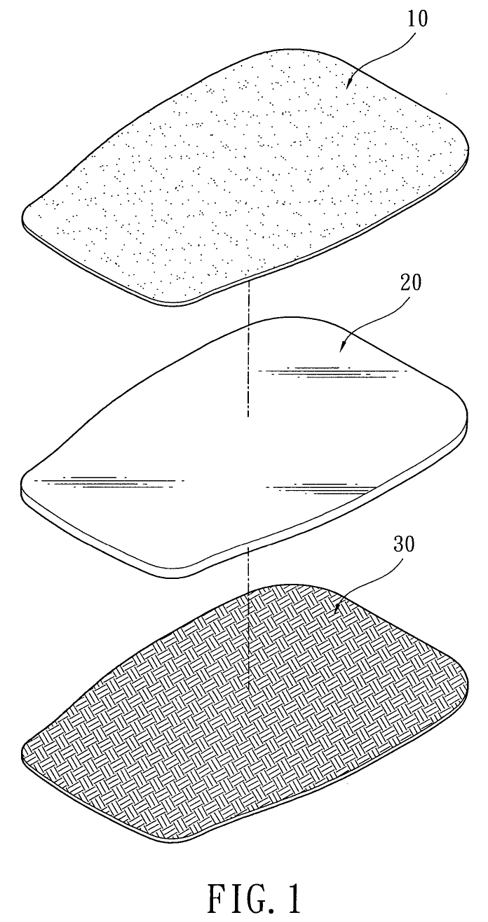

Referring to FIGS. 1 to 3, the mat according to the invention is composed of three layers of materials, respectively being an upper layer 10, a middle layer 20 and a lower layer 30. The upper layer 10 is a durable weave cloth, non-woven fabric, fluffy rug, textile rug, anti-slip thermoplastic rubber (TPR) or thermoplastic elastomer (TPE), etc. As the upper layer 10 requires aesthetic, anti-slip and durable characteristics, it is preferably be made of weave cloth, non-woven fabric, fluffy rug, textile rug, thereby obtaining a fine and delicate quality and feeling, as well as a moderate anti-slip function. In consideration of anti-slip purposes, the mat is preferably made of thermoplastic rubber (TPR) or thermoplastic elastomer (TPE), both of which are tough and durable, and can accomplish a protection for the middle layer 20. While the middle layer 20 can be a relatively thick layer for providing the entire mat a comfortable touch feeling, it need be made of a material that is lightweight, water unabsorbable, formable to a contour of a supportive mat, preferably being made of cross-link polythene or EVA foam material. As for the lower layer 30, the anti-slip function is required thereof. Therefore, it is preferably made of an anti-slip thermoplastic rubber (TPR) laminate.

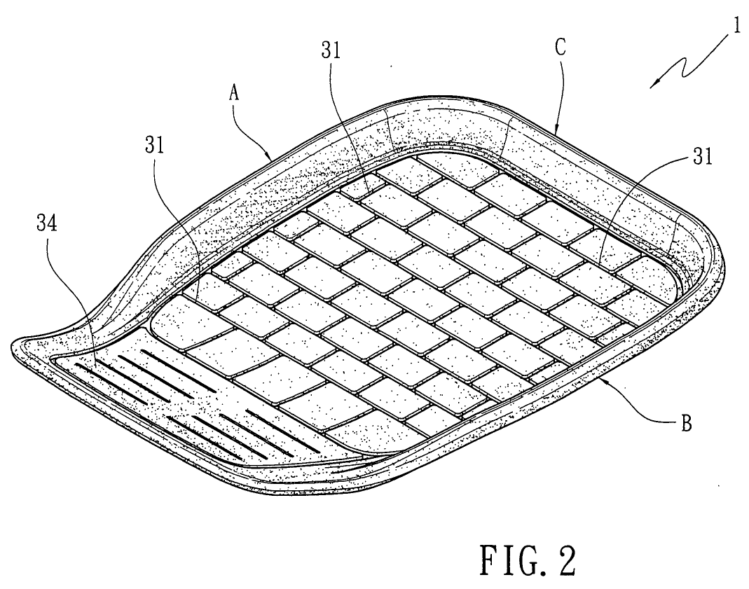

As shown in FIG. 2, the middle layer 20 is a relatively thick layer made of thermoplastic foam board, which preferably has a thickness of 3 mm to 6 mm, such that the mat can be lightweight, shock absorbent, sound-proof, water-proof, elastic and comfortable. Meanwhile, as the total weight of the mat is considerably reduced, it can be carried easily. When bonding the upper layer 10 to the upper surface of the middle layer 20, the foam board on the upper surface of the middle layer 20 is heated by torch of high temperature, such that the surface of the middle layer 20 will be softened and in form of a melted viscose for bonding to the upper layer 10 after being pressed by a roller. Such bonding does not need the application of any solvent glue or adhesive.

While the upper layer 10 can be a layer of thermoplastic rubber (TPR) or thermoplastic elastomer (TPE), the thermoplastic rubber (TPR) or thermoplastic elastomer (TPE) layer is applied onto the upper surface of the middle layer 20 via extrusion technique. When the thermoplastic rubber (TPR) or thermoplastic elastomer (TPE) is still under a melted condition, is has viscosity for bonding the upper layer 10 and middle layer 20 together without the need of applying any solvent glue. The bonding of the upper layer 10 and the middle layer 20 can be firmer via an appropriate press by a roller. In view of the above, the upper layer 10 is preferably made of textile fiber materials, such as weave cloth, non-woven fabric, fluffy rug, textile rug, etc., which after bonding to the upper surface of the middle layer 20 may has an anti-slip function in some degree, as well as present a fine and delicate quality. Besides, as the upper layer 10 is made of thermoplastic rubber (TPR) or thermoplastic elastomer (TPE), after it cools down, it can present a better anti-slip function for obtaining a safety in use, i.e. preventing the user from slip when his/her show soles or feet are stepping on the mat. Besides, the upper layer 10 may also protect the middle layer 20 and allow the entire mat more durable. When the upper layer 10 and middle layer 20 are pressed by a roller after they cool down, and bonded completely and integrally to become one piece, which can have a length from centimeters to meters, the bonded upper layer 10 and middle layer 20 of a long length can be rolled up to a continuous roll to ease storage and transportation.

Furthermore, the middle layer 20 is bonded to the lower layer 30 via extrusion technique, with the thermoplastic rubber (TPR) applied onto the lower surface of the middle layer 20. As the thermoplastic rubber (TPR) lower layer 30 is in form of a melted liquid after being extruded, it is viscous to bond with the middle layer 20 without the need of applying any solvent glue. The composite of the middle layer 20 and the lower layer 30 can be pressed by a relief roller, such that relief patterns will form on the surface of the thermoplastic rubber (TPR) lower layer 30. After the thermoplastic rubber (TPR) cools down, it becomes an anti-slip layer. As the thermoplastic rubber (TPR) layer is soft, elastic and anti-slip, the relief patterns on it can further increase the friction factor of its underside, thereby increasing the anti-slip function. Besides, the irregular air clearances formed between the relief patterns and the contact ground will enhance ventilation between the mat and the contact ground, such that a hygiene purpose can be obtained and that mold and bacterium would not easily occur.

The aforementioned mat structure comprising three laminated layers can be cut into specific sizes and contours as desired, and put into an oven to heat until it is softened, and then put in a mold to press and form a basin shape to serve as a vehicle floor mat 1, which would have an upstanding rim 40 at two sides A, B, and the underside C, whereas the center of the mat will form a recession of a 3D space. The mat having an upstanding rim can be utilized as a luggage pallet mat for vans.

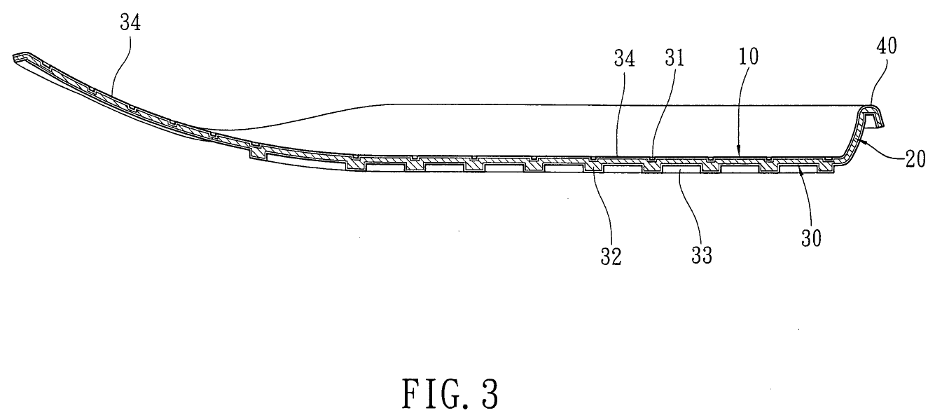

As shown in FIGS. 2 and 3, when the upper layer 10, middle layer 20 and lower layer 30 of the mat body are bonded together after being pressed by a roller, the mat can be cut and put into an oven to heat until it is softened, and then put into a mold to press and form grooves 31, protrusions 34 on the top surface, as well as ribs 32 and recessions 33 on the underside surface.

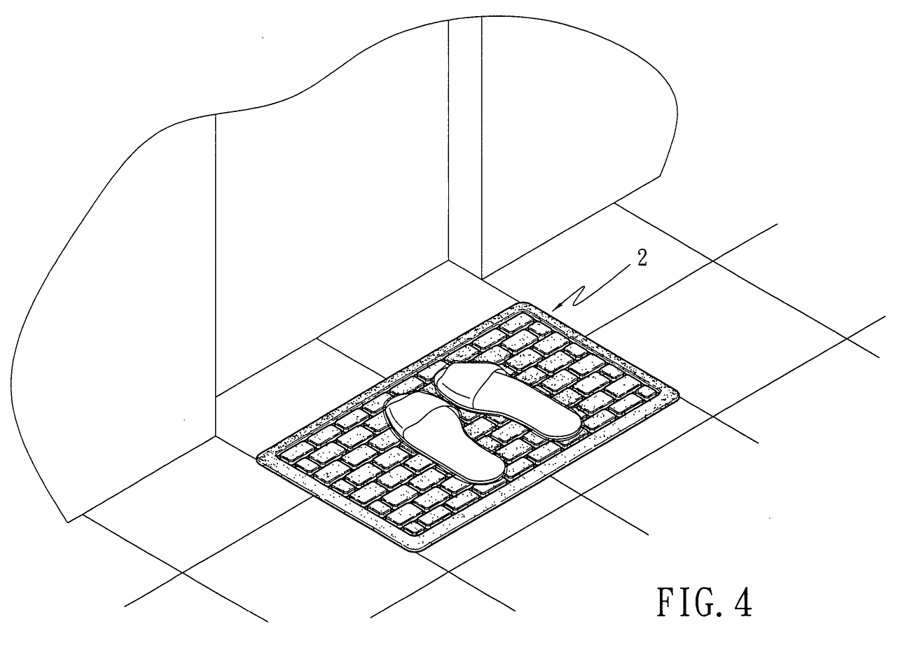

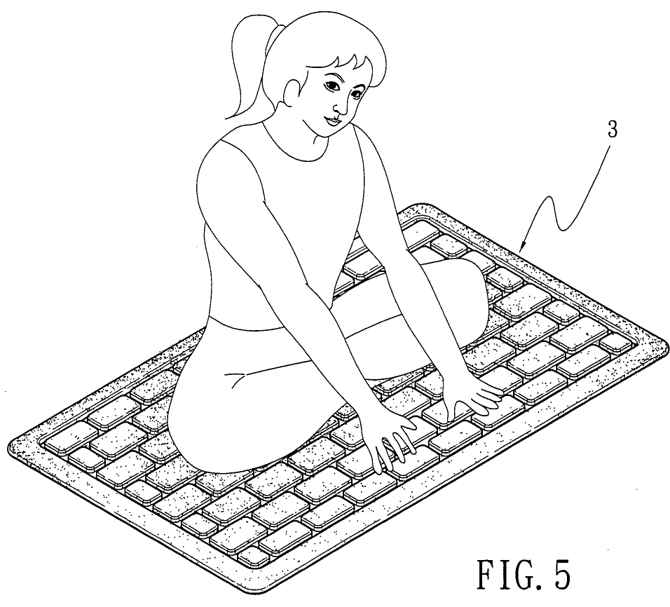

As shown in FIGS. 4 and 5, the mat body can be cut into various sizes and contours for serving as, e.g. doormat 2 (as shown in FIG. 4), bathroom mat, or sports mat such as yoga mat (as shown in FIG. 5) which is soft and anti-slip. The mat can allow the user to use in various locusci.

Concluded above, the invention can obtain the purposes as desired, i.e., the one piece mat not only can be served as vehicle floor mat, doormat and sports mat and applicable to various locusci, but also can reduce the manufacture cost. Although specific embodiments have been illustrated and described, it will be obvious to those skilled in the art that various modifications may be made without departing from what is intended to be limited solely by the appended claims.

What is claimed is:

1. A one piece floor mat for use as a vehicle floor mat, doormat and sports mat, comprising a three-layer laminated mat body that includes an upper layer, a middle layer and a lower layer, comprising:
the upper layer has a surface of a durable material;
the middle layer being relatively thick is made of a foam board;
the lower layer is a thin layer of anti-slip thermoplastic; and
the melted surface of the middle layer is served as an interface for bonding the upper layer and the middle layer together, and the melted surface of the lower layer is served as an interface for bonding the middle layer and the lower layer together, such that the upper layer, middle layer and lower layer can be pressed by a roller to bond together and become a whole after they cool down, without the need of applying any glue or adhesive.

2. The one piece floor mat for use as a vehicle floor mat, doormat and sports mat according to claim 1, wherein the middle layer is a relatively thick layer of a cross-link polythene material, having a thickness of 3 mm˜6 mm.

3. The one piece floor mat for use as a vehicle floor mat, doormat and sports mat according to claim 1, wherein the middle layer is a relatively thick layer of an EVA foam material, having a thickness of 3 mm˜6 mm.

4. The one piece floor mat for use as a vehicle floor mat, doormat and sports mat according to claim 1, wherein the upper layer can be fabrics, including weave cloth, non-woven fabric, etc.

5. The one piece floor mat for use as a vehicle floor mat, doormat and sports mat according to claim 1, wherein the upper layer can be rugs, including fluffy rug, textile rug, etc.

6. The one piece floor mat for use as a vehicle floor mat, doormat and sports mat according to claim 1, wherein the upper layer can be an anti-slip thermoplastic rubber (TPR) layer.

7. The one piece floor mat for use as a vehicle floor mat, doormat and sports mat according to claim 1, wherein the upper layer can be a thermoplastic elastomer (TPE) layer.

8. The one piece floor mat for use as a vehicle floor mat, doormat and sports mat according to claim 1, wherein the mat body composed of three laminated layers of materials can be cut into various sizes and contours depending on the specific need in various locusci, being such as a vehicle floor mat, a doormat, or a sports mat.

9. The one piece floor mat for use as a vehicle floor mat, doormat and sports mat according to claim 8, wherein the mat body composed of three laminated layers of materials is cut and heated in an oven, and then put into a mold to press and form a basin with an upstanding rim for serving as a vehicle floor mat or a luggage pallet mat.
